(19) United States
(12) Patent Application Publication
(10) Pub. No.: US 2005/0140259 A1
(43) Pub. Date: Jun. 30, 2005

(54) Flat lamp

(75) Inventors: Hyoung-bin Park, Gyeonggi-do (KR); Hidekazu Hatanaka, Gyeonggi-do (KR); Young-mo Kim, Gyeonggi-do (KR); Seong-eui Lee, Gyeonggi-do (KR); Sang-hun Jang, Gyeonggi-do (KR); Seung-hyun Son, Gyeonggi-do (KR); Gi-young Kim, Gyeonggi-do (KR); Xiaoqing Zeng, Gyeonggi-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Gyeonggi-do (KR)

(21) Appl. No.: 11/020,213

(22) Filed: Dec. 27, 2004

(30) Foreign Application Priority Data
Dec. 30, 2003 (KR) 10-2003-0100622

(51) Int. Cl. H01J 63/04; H01J 65/00

(52) U.S. Cl. 313/234; 313/581; 313/635; 313/582

(57) ABSTRACT

Provided is a flat lamp. The flat lamp comprises a front substrate and a rear substrate spaced apart from each other, forming a discharge space therebetween. Also, the flat panel includes electrodes forming an electric field in the discharge space to cause a discharge. At least one of through hole for allowing visible light emitted from the discharge space to pass through are formed in at least one of the electrodes.

### BACKGROUND OF THE INVENTION

Priority is claimed to Korean Patent Application No. 10-2003-0100622 filed on Dec. 30, 2003 in the Korean Intellectual Property Office, the disclosure of which is incorporated herein in its entirety by reference.

1. Field of the Invention

The present invention relates to a flat lamp, and more particularly, to a flat lamp with minimal dark area caused by electrodes formed on a front display panel and having increased brightness, luminance efficiency and minimal power consumption.

2. Description of the Related Art

Flat lamps are typically used as backlights for liquid crystal displays (LCDs). Flat lamps have been developed into surface discharge lamps and facing discharge lamps, which use an entire lower portion of light emitting surface as discharging spaces. Flat lamps have also developed using edge-lighting method, which uses a cold cathode fluorescent lamp or using a direct-lighting method for high luminance efficiency and uniform brightness.

Surface discharge lamps have stable discharge characteristics but lower brightness than the facing discharge lamps. On the other hand, facing discharge lamps have higher brightness but has low luminance efficiency and unstable discharge characteristics due to excessive current.

FIGS. 1 and 2 illustrate a flat lamp that solves the drawbacks of the low brightness of the surface discharge lamp and the unstable discharge characteristics of the facing discharge lamp.

Referring to FIGS. 1 and 2, a front substrate 10 and a rear substrate 20 form a discharge space 80 filled by a discharge gas and are spaced a predetermined distance apart by walls 30. Fluorescent layers 61 are formed an inner surfaces of the front substrate 10 and the rear substrate 20. A pair of first electrodes 31 and 32 and a pair of second electrodes 41 and 42 are formed on outer surfaces of the front substrate 10 and the rear substrate 20, respectively. The electrodes 31, 32, 41, and 42 of each pair are disposed opposite each other and the first front electrode 31 and the first rear electrode 32 opposite the first front electrode 31 is maintained at the same potential so that a discharge is not induced between them. Also, the same potential is maintained between the second front electrode 41 and the second rear electrode 42 so that a discharge is not induced between them. However, there is a predetermined level of potential difference between the first pair of electrodes 31 and 32 and the second pair of electrodes 41 and 42, and a discharge is induced between the pairs of electrodes in a direction parallel to the front substrate 10 and the rear substrate 20.

In this flat lamp, the advantages of the conventional surface discharge lamp and the conventional facing discharge lamp are maintained. However, in this structure, since the electrodes are formed on the front substrate 10 that emits light, brightness and uniformity of light decrease when the electrodes are composed of an opaque material because the electrodes become dark areas. When the electrodes are composed of a transparent material, manufacturing costs increase and luminance efficiency decreases due to resistance of the transparent electrodes.

### SUMMARY OF THE INVENTION

Embodiments of the present invention provides a flat lamp with increased brightness and luminance efficiency and reduced power consumption and smaller dark areas caused by electrodes formed on a front substrate.

According to an embodiment of the present invention, there is provided a flat lamp comprising a front substrate and a rear substrate spaced apart from each other forming a discharge space therebetween, and electrodes producing an electric field in the discharge space to cause discharge, wherein at least one of the electrodes has at least one through hole for allowing visible light emitted from the discharge space to pass through.

The electrode can include a pair of first and second front electrodes formed on one surface of the front substrate, and the through hole can be formed in at least one of the first and second front electrodes.

The flat lamp can further comprise a pair of first and second rear electrodes formed on one surface of the rear substrate.

The through hole can be formed in a portion besides the perimeter of at least one of the first and second front electrodes.

A plurality of through holes can be formed in at least one of the first and second front electrodes. In this case, the through holes may have equal sizes or the through hole in far position from a mid-line between the first front electrode and the second front electrode may have a smaller size than the through hole in near position from the mid-line.

The flat lamp can further comprise walls to maintain a predetermined distance between the front substrate and the rear substrate and to seal the discharge space.

Fluorescent layers can be formed on an inner surface of the front substrate and the rear substrate.

A reflection layer can be formed on an inner surface of the rear substrate to reflect toward the front substrate visible light generated in the discharge space.

### BRIEF DESCRIPTION OF THE DRAWINGS

The above and other features and advantages of the present invention will become more apparent by describing in detail preferred embodiments thereof with reference to the attached drawings in which:

FIG. 1 is a partial perspective view of a conventional flat lamp;

FIG. 2 is a cross-sectional view of the flat lamp of FIG. 1;

FIG. 3 is a perspective view of a flat lamp according to an embodiment of the present invention;

FIG. 4 is a cross-sectional view of the flat lamp of FIG. 3;

FIG. 5 is a plane view of a flat lamp according to another embodiment of the present invention;

FIG. 6 is a plane view of a flat lamp according to still another embodiment of the present invention;

FIGS. 7a and 7b illustrate calculated electrical field distributions in a conventional flat lamp and a flat lamp according to an embodiment of the present invention; and

FIGS. 8a and 8b illustrate calculations of energy used for producing excited state gas in a conventional flat lamp and a flat lamp according to an embodiment of the present invention.

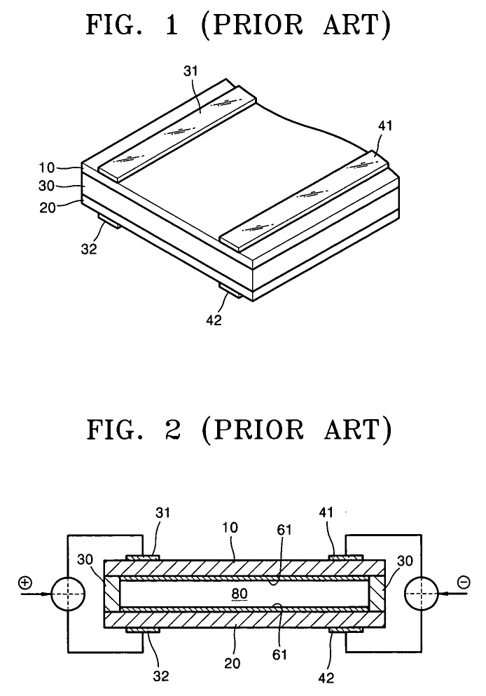

### DETAILED DESCRIPTION OF THE INVENTION

The present invention will now be described more fully with reference to the accompanying drawings in which preferred embodiments of the invention are shown. Like reference numerals refer to like elements throughout the drawings.

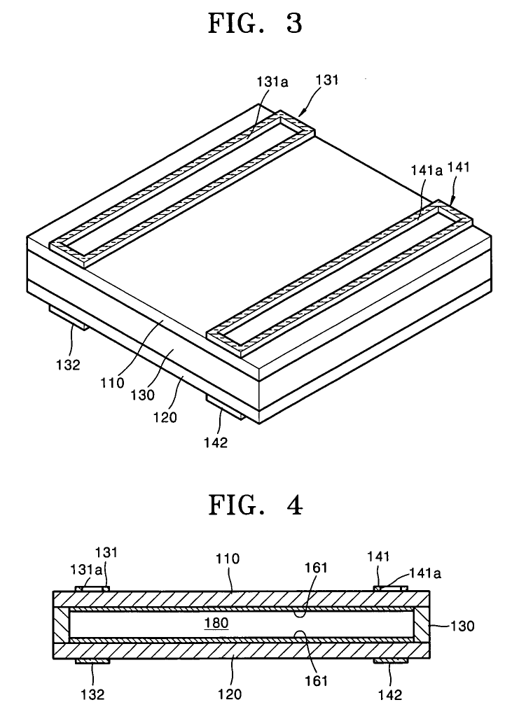

FIG. 3 is a perspective view of a flat lamp according to an embodiment of the present invention, and FIG. 4 is a cross-sectional view of the flat lamp of FIG. 3.

Referring to FIGS. 3 and 4, a front substrate 110 and a rear substrate 120 face each other and are spaced a predetermined distance apart, thereby forming a discharge space 180 therebetween. The front substrate 1 10 and the rear substrate 120 may be glass substrates, for instance. A wall 130 maintaining the predetermined distance between the front substrate 1 10 and the rear substrate 120 and sealing the discharge space 180 is disposed between the front substrate 110 and the rear substrate 120. The discharge space 180 sealed by the wall 130 is filled with a discharge gas.

Fluorescent layers 161 emitting visible light when discharge occurs can be formed on inner surfaces of the front substrate 110 and the rear substrate 120. A reflection layer (not shown) may be interposed between the fluorescent layer 161 and the rear substrate 120 to reflect all emitted visible light toward the front substrate 110. In the present embodiment, the visible light may be directly generated by the discharge gas filled in the discharge space 180.

Electrodes producing a predetermined electric field in the discharge space 180 to cause a discharge can be formed on the front substrate 110 and the rear substrate 120. More specifically, a pair of first and second rear electrodes 132 and 142 spaced a predetermined distance apart is formed on an outer surface of the rear substrate 120. A discharge in a direction parallel to the rear substrate 120 is induced by a predetermined potential difference between the first rear electrode 132 and the second rear electrode 142. The first and the second rear electrodes 132 and 142 may be formed on inner surfaces of the rear substrate 120.

A pair of first and second front electrodes 131 and 141 spaced a predetermined distance apart is formed on an outer surface of the front substrate 110. A discharge in a direction parallel to the front substrate 120 is induced by a predetermined potential difference between the first front electrode 131 and the second front electrode 141. The first and the second front electrodes 132 and 142 may be formed on inner surfaces of the front substrate 120. The first front electrode 131 and the first rear electrode 132 maintain the same potential, and thus, a substantial discharge is not induced between them. Also, little or no discharge is induced between the second front electrode 141 and the second rear electrode 142 because the two electrodes are maintained at the same potential levels.

Through holes 131a and 141a for allowing visible light emitted from the discharge space 180 to pass through are formed in the first and second front electrodes 131 and 141. The through holes 131a and 141a are formed in a portion beside the perimeter of the first and second front electrodes 131 and 141.

In this structure, when there are predetermined potential differences between the first and second front electrodes 131 and 141 and the first and second rear electrodes 132 and 142, visible light is generated in the discharge space 180 by gas discharge. The generated visible light is emitted through the front substrate 110. At this time, a majority of light that is emitted toward the first and the second front electrodes 131 and 141 passes via the through holes 131a and 141a in the first and the second front electrodes 131 and 141. Therefore, the dark areas caused by the first and the second front electrodes 131 and 141 on the front substrate 110 are smaller than those in the conventional art, and therefore, luminance efficiency, brightness, and uniformity of light emitted from the front substrate 110 are increased.

As described above, a through hole is formed in each of the first and second front electrodes 131 and 141. However, the through hole may be formed in only one of the first front electrode 131 and the second front electrode 141.

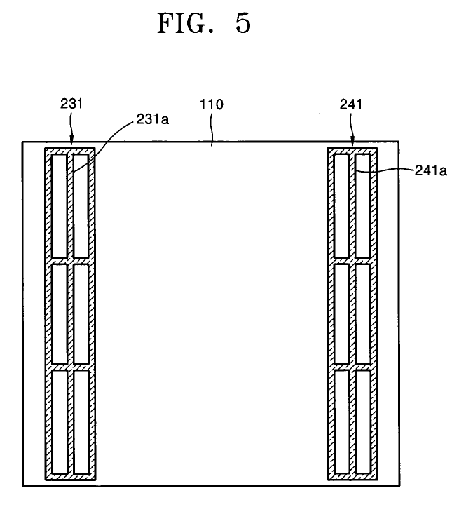

FIG. 5 is a plane view of a flat lamp according to another embodiment of the present invention. Referring to FIG. 5, a plurality of through holes 231a and 241a are respectively formed in the first and the second front electrodes 231 and 241 formed on an outer surface of the front substrate 110. The size of the through holes 231a and 241a may be equal.

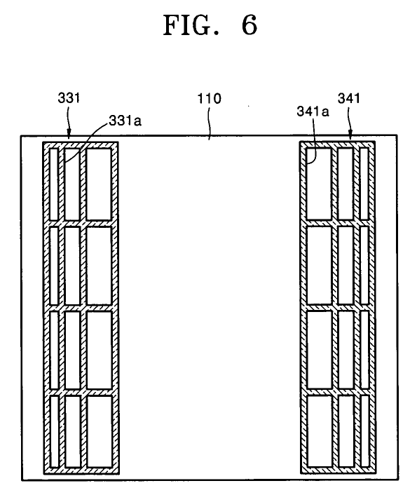

FIG. 6 is a plane view of a flat lamp according to still another embodiment of the present invention. Referring to FIG. 6, a plurality of through holes 331a and 341 a are respectively formed in the first and the second front electrodes 331 and 341 formed on an outer surface of the front substrate 110. Preferably, the sizes of the through holes 331 a and 341 a are not all the same. The sizes of the through holes 331 a and 341 a may become smaller farther from the mid-line between the first front electrode 331 and the second front electrode 341. When the through holes 331a and 341a are formed in the first and the second front electrodes 331 and 341, an average distance between the first front electrode 331 and the second front electrode 341 can be greater than in the conventional art. Accordingly, an average discharge path between the first front electrode 331 and the second front electrode 341 can be increased, thereby increasing light emission efficiency.

As described above, a plurality of through holes are formed in each of the first and second front electrodes 331 and 341. However the plurality of through holes may be formed in only one of the first front electrode 331 and the second front electrode 341.

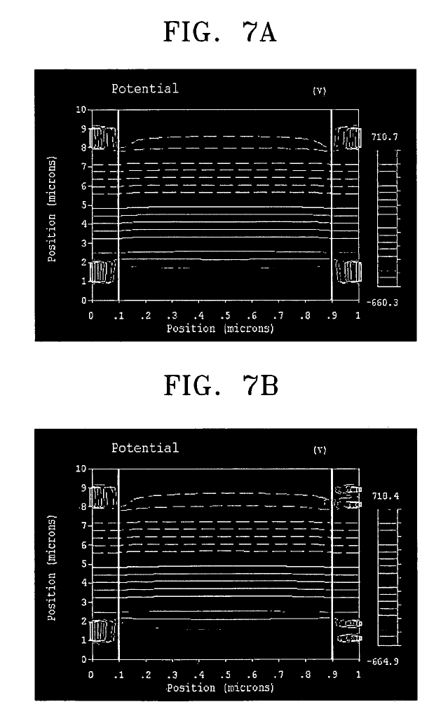

FIGS. 7a and 7b illustrate calculations of electrical field distributions in a conventional flat lamp and the flat lamp of FIG. 4 according to an embodiment of the present invention. In FIGS. 7a and 7b, the rear substrate is located between 0 and 0.1 μm and the front substrate is located between 0.9 and 1 μm.

Referring to FIGS. 7a and 7b, even though the shapes of electrodes formed on the front substrate are different, the field shapes in the discharge space are identical to the conventional flat lamp and the flat lamp according to an embodiment of the present invention. Therefore, the discharge characteristics of the flat lamp according to an embodiment of the present invention is almost the same as that of the conventional art, but the dark areas caused by the electrodes formed on the front substrate is reduced, thereby improving brightness and uniformity of light and increasing luminance efficiency.

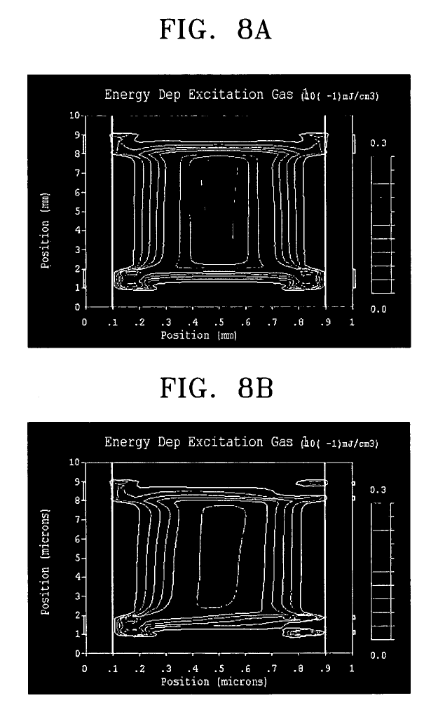

FIGS. 8a and 8b illustrate calculations of energy used for producing excited state gas in a conventional flat lamp and the flat lamp of FIG. 4 according to an embodiment of the present invention. In the FIGS. 8a and 8b, the rear substrate is located between 0 and 0.1 μm and the front substrate is located between 0.9 and 1 μm.

Referring to FIGS. 8a and 8b, magnitudes and distributions of energy used for producing excited state gas are almost the same for the conventional flat lamp and the flat lamp according to an embodiment of the present invention. Since the density of the excited state gas is proportional to the amount of generated visible light, the amount of the generated visible light are almost the same in the conventional flat lamp and the flat lamp according to an embodiment of the present invention. However, energy efficiency, which is calculated by dividing the energy used for producing excited state gas by input electrical energy, is approximately 2.4% higher in the flat lamp according to an embodiment of the present invention than in the conventional flat lamp. This is an effect of the larger distance between the two electrodes formed on the front substrate of the flat panel lamp according to an embodiment of the present invention. When considering that the light emitting area of the flat lamp according to an embodiment of the present invention is 15% larger than that of the conventional flat lamp, an overall improvement of the brightness and luminance efficiency is approximately 17.8%.

As described above, the flat lamp according to the present invention has the following advantages.

First, dark areas caused by electrodes formed on a front substrate of the flat lamp can be minimized by forming through holes in the electrodes for passing light emitted by discharge. Therefore, brightness and uniformity of light emitted via the front substrate can be improved. Also, luminance efficiency can be increased and power consumption can be reduced.

Second, luminance efficiency can be increased by lengthening an average gap between the two electrodes formed on the front substrate to lengthen a discharge path.

While the present invention has been particularly shown and described with reference to exemplary embodiments thereof, it will be understood by those skilled in the art that various changes in form and details may be made therein without departing from the spirit and scope of the invention as defined by the appended claims.

1. A flat lamp comprising:
a front substrate and a rear substrate spaced apart from the front substrate such that a discharge space is formed between the front substrate and the rear substrate; and
a plurality of electrodes producing an electric field in the discharge space for causing discharge, wherein at least one of the electrodes has at least one through hole for allowing visible light emitted from the discharge space to pass through.

2. The flat lamp of claim 1, wherein the electrodes include a pair of first and second front electrodes disposed on one surface of the front substrate, and the through hole is formed in at least one of the first and second front electrodes.

3. The flat lamp of claim 2 further comprising a pair of first and second rear electrodes disposed on one surface of the rear substrate.

4. The flat lamp of claim 2, wherein the through hole is formed in a portion beside the perimeter of at least one of the first and second front electrodes.

5. The flat lamp of claim 2, wherein a plurality of through holes are formed in at least one of the first and second front electrodes.

6. The flat lamp of claim 5, wherein the through holes have equal sizes.

7. The flat lamp of claim 5, wherein the through hole in far position from a mid-line between the first front electrode and the second electrode has a smaller size than the through hole in near position from the mid-line.

8. The flat lamp of claim 1 further comprising walls maintaining a predetermined distance between the front substrate and the rear substrate and sealing the discharge space.

9. The flat lamp of claim 1, wherein a fluorescent layers are formed on inner surfaces of the front substrate and the rear substrate.

10. The flat lamp of claim 1, wherein a reflection layer is formed on an inner surface of the rear substrate to reflect toward the front substrate visible light generated in the discharge space.
